(19) United States
(12) Patent Application Publication
(10) Pub. No.: US 2026/0233180 A1
(43) Pub. Date: Aug. 13, 2026

(54) FLEXIBLE PULPING MACHINE WITH ANTI-CLOGGING DEVICES FOR THERMAL POWER PLANT

(71) Applicant: HUANENG QINBEI POWER GENERATION CO., LTD., Jiyuan (CN)

(72) Inventors: Yukai ZHENG, Jiyuan (CN); Zhenfei WANG, Jiyuan (CN); Shengjie REN, Jiyuan (CN); Xin AI, Jiyuan (CN); Guangsheng JIANG, Jiyuan (CN); Shaoxiang ZHOU, Jiyuan (CN); Guangjun WEI, Jiyuan (CN); Nianjie XUE, Jiyuan (CN); Bingxin ZHANG, Jiyuan (CN)

(73) Assignee: HUANENG QINBEI POWER GENERATION CO., LTD., Jiyuan (CN)

(21) Appl. No.: 19/438,552

(22) Filed: Dec. 31, 2025

Related U.S. Application Data
(63) Continuation of application No. PCT/CN2025/118112, filed on Aug. 30, 2025.

(30) Foreign Application Priority Data
Jan. 20, 2025 (CN) 2025100818808

(51) Int. Cl. B01F 35/00

(52) U.S. Cl. CPC B01F 35/79

(57) ABSTRACT

Disclosed is a flexible pulping machine with anti-clogging devices for a thermal power plant, including a pre-positioning unit, which includes a fixed base, a connecting plate, and a clamp. An end face of the connecting plate is connected to the bottom of a vibrator D, and the connecting plate includes a bulge, which penetrates the fixed base and extends into the interior thereof. The clamp is snap-fitted with the bulge, thereby achieving the fixation between the fixed base and the connecting plate. With the fitting between the connecting plate and the fixed base, the vibrator can be quickly mounted at a position close to the discharge port of the storage tank. When the vibrator is started, its vibration can cause continuous rapping on the side wall of the storage tank to make the material inside move, thereby facilitating the discharge of the raw limestone accumulated at the discharge port.

### CROSS-REFERENCE TO RELATED APPLICATIONS

The application claims priority to Chinese patent application No. 2025100818808, filed on Jan. 20, 2025, the entire contents of which are incorporated herein by reference.

### TECHNICAL FIELD

The present application relates to the field of pulping for a thermal power plant, and in particular to a flexible pulping machine with anti-clogging devices for a thermal power plant.

### BACKGROUND

In wet desulfurization systems, the preparation of absorbents is key to ensuring the desulfurization efficiency and operational stability. Traditionally, limestone slurry is the most commonly used absorbent, and there are many preparation methods. According to the raw materials that can be acquired on the market, the methods include preparing from finished powdered absorbents, preparing by wet ball mill, and preparing by dry ball mill.

In the actual production process of a system, the process for preparing limestone slurry is not flexible enough when the raw materials come from different sources or with varying quality. In order to adapt to the changing raw material conditions and maintain the continuity and stability of the system, it is usually necessary to include all the machines corresponding to these three preparing methods, which not only significantly increases the initial capital outlay, but also leads to higher long-term operating costs due to low equipment utilization, as well as higher requirements on maintenance management. Moreover, during the pulping process, materials tend to clog the discharge port, resulting in lower work efficiency.

### SUMMARY

### Technical Problem

The purpose of the present application is to solve the low equipment utilization due to the clogging of pulping machines in the prior art.

### Technical Solutions

The technical problem described above is solved by the following technical solution. The present application provides a flexible pulping machine with anti-clogging devices for a thermal power plant, including a pre-positioning unit, which includes a fixed base, a connecting plate arranged at one end of the fixed base, and a clamp penetrating a side wall of the fixed base;
an end face of the connecting plate is connected to the bottom of a vibrator D, and the connecting plate includes a bulge arranged at an end thereof; and
the bulge penetrates the fixed base and extends into the interior thereof, and the clamp is snap-fitted with the bulge, thereby realizing the fixation between the fixed base and the connecting plate.

In a preferred embodiment method for the flexible pulping machine with anti-clogging devices for a thermal power plant according to the present application, the fixed base includes a through hole on a side wall thereof and a retainer plate arranged in the through hole;
the clamp includes a groove on an end face thereof and a first reset member arranged in the groove; and
the clamp passes through the through hole and extends to the outer side thereof, and the groove is adapted to the retainer plate.

In a preferred embodiment method for the flexible pulping machine with anti-clogging devices for a thermal power plant according to the present application, an end of the clamp is a trapezoidal structure, and the outer wall of the bulge is provided with a slot adapted to the end of the clamp;
one end of the first reset member contacts against the groove, and the other end thereof contacts against the bulge; and
the first reset member can push the end of the clamp to be snapped in the inner side of the slot.

In a preferred embodiment method for the flexible pulping machine with anti-clogging devices for a thermal power plant according to the present application, the fixed base further includes a guide sleeve arranged therein, and a pressure rod is arranged in the guide sleeve;
the clamp further includes a middle hole on a side wall thereof;
the pressure rod includes a second reset member arranged at an end thereof and a guide rod arranged on a side wall of the pressure rod;
the guide rod is adapted to the middle hole, and an end of the guide rod passes through to the inner side of the middle hole; and
the movement of the pressure rod in the vertical direction can drive the clamp to move in the horizontal direction.

In a preferred embodiment method for the flexible pulping machine with anti-clogging devices for a thermal power plant according to the present application, a push rod is arranged in the pressure rod, and the push rod penetrates the fixed base and extends to the outer side thereof;
the push rod includes a third reset member arranged therein and a disc arranged at an end of the push rod; and
one end of the third reset member contacts against the inner wall of the pressure rod, and the other end contacts against the inner wall of the push rod.

In a preferred embodiment method for the flexible pulping machine with anti-clogging devices for a thermal power plant according to the present application, the push rod further includes a protrusion arranged on the side wall thereof;
an end of the push rod passes through to the inner side of the pressure rod; and
a chute is provided on the inner wall of the pressure rod, and the chute is adapted to the protrusion.

In a preferred embodiment method of the flexible pulping machine with anti-clogging devices for a thermal power plant according to the present application: the chute includes a vertical section L1, and the protrusion moves along the vertical section L1;

The push rod moves toward the inside of the pressure rod.

In a preferred embodiment method for the flexible pulping machine with anti-clogging devices for a thermal power plant according to the present application, the chute further includes a horizontal section L2, and the protrusion moves in the horizontal section; and
the push rod can drive the pressure rod to move synchronously in the vertical direction.

In a preferred embodiment method for the flexible pulping machine with anti-clogging devices for a thermal power plant according to the present application, the flexible pulping machine further includes a storage unit, which includes a storage tank and a receiving hopper arranged in the storage tank;
the fixed base is mounted on the side wall at the bottom of the storage tank;
the receiving hopper divides the interior of the storage tank into a first storage space M1 and a second storage space M2;
a first feeding member is provided on one side of the first storage space M1, and a second feeding member is connected to the second storage space M2;
the first storage space M1 discharges the content through a second discharge pipe connected to the bottom of the receiving hopper; and
the second storage space M2 discharges the content through a first discharge pipe connected to the bottom of the storage tank.

The beneficial effects of the present application include the following. With the fitting between the connecting plate and the fixed base, the vibrator can be quickly mounted at a position close to the discharge port of the storage tank. When the vibrator is started, its vibration can cause continuous rapping on the side wall of the storage tank to make the material inside move, thereby facilitating the discharge of the raw limestone accumulated at the discharge port.

In addition, another purpose of the present application is to solve the laborious installation process for the vibrators in the prior art.

The technical problem described above is solved by the following technical solution. The present application provides a method for mounting the flexible pulping machine with anti-clogging devices for a thermal power plant, including S1: connecting and fixing a vibrator to a connecting plate;
S2: inserting the connecting plate into the inner side of a fixed base, and further fixing the positions of the fixed base and the connecting plate by using the fitting between a clamp and the connecting plate; and
S3: then making bolts penetrate the connecting plate and engage with screw holes inside the fixed base, so that the vibrator can be fixed at the bottom of a storage tank.

### Beneficial Effects

When the mounting method described above is used, the vibrator can be mounted and fixed easily, effectively reducing the labor intensity of the staff and improving the work efficiency.

### BRIEF DESCRIPTION OF DRAWINGS

In order to more clearly illustrate the technical solution of the embodiments of the present application, the following is a brief introduction to the drawings required for use in the embodiments of the present application. Obviously, the drawings below only relate to some embodiments of the present application and are not limitations of the present application. Specifically,

FIG. 1 is a schematic diagram of a three-dimensional structure of a pulping machine for a thermal power plant;

FIG. 2 is a partial cross-sectional view of a storage tank;

FIG. 3 is a schematic diagram of a mounting structure of a vibrator;

FIG. 4 is a partial cross-sectional view of a fixed base;

FIG. 5 is a schematic diagram of a connection structure between a fixed base and a connecting plate;

FIG. 6 is an exploded view of a structure of a pre-positioning unit; and

FIG. 7 is a partial enlarged view of position A in FIG. 6.

### DETAILED DESCRIPTION OF THE EMBODIMENTS

In order to enable those skilled in the art to better understand the present application, the present application will be further described in detail below in combination with specific embodiment methods and drawings.

The terms used in the present application are those general terms currently widely used in the art with respect to the features of the present application, but those general terms may vary according to the intentions, precedents, or new technologies of those of ordinary skill in the art. In addition, specific terms can be selected by the applicant, and in this case, their specific meanings will be described in the specification of the present application. Therefore, the terms used in the specification should not be understood as simple names, but are based on the meanings of the terms and the overall description of the present application.

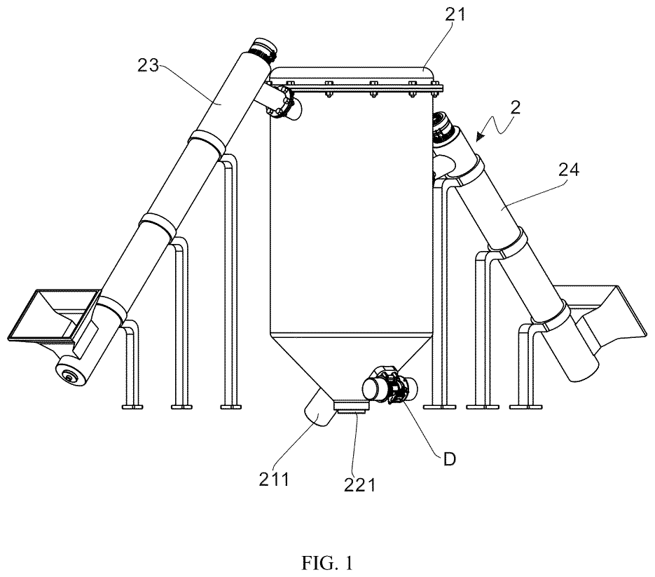

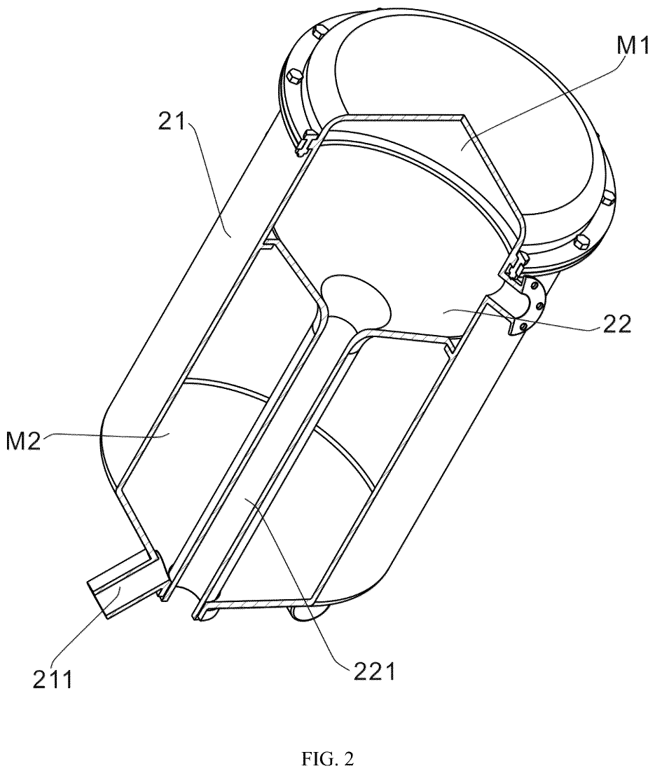

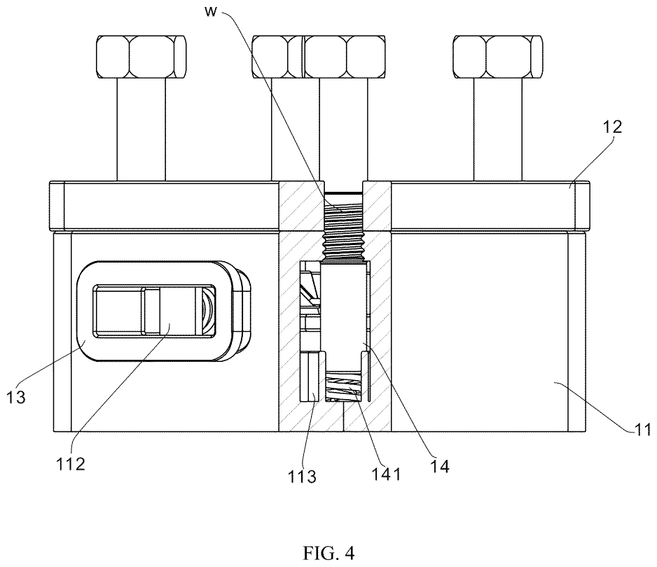

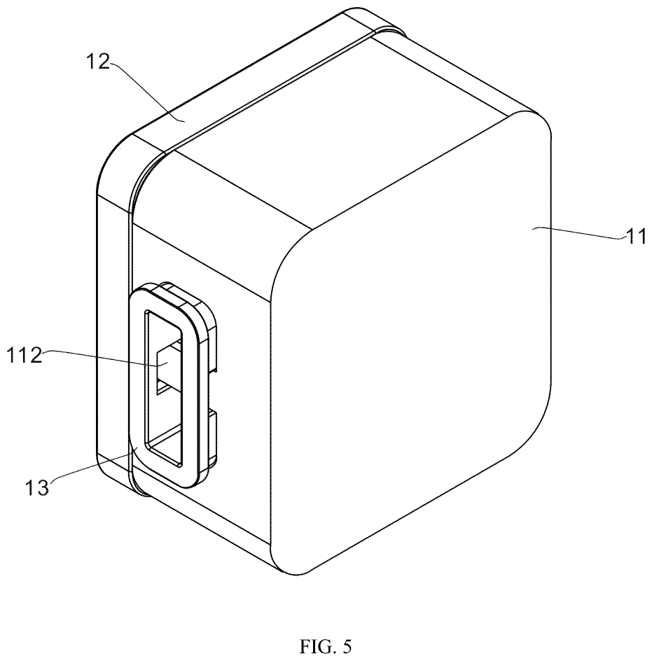

Referring to FIG. 1 to FIG. 7, this embodiment provides a flexible pulping machine with anti-clogging devices for a thermal power plant, including a pre-positioning unit 1, which includes a fixed base 11, a connecting plate 12 arranged at one end of the fixed base 11, and a clamp 13 penetrating a side wall of the fixed base 11; an end face of the connecting plate 12 is connected to the bottom of a vibrator D, and the connecting plate 12 includes a bulge 121 arranged at an end thereof; the bulge 121 penetrates the fixed base 11 and extends into the interior thereof, and the clamp 13 is snap-fitted with the bulge 121, thereby realizing the fixation between the fixed base 11 and the connecting plate 12.

In this embodiment, with the fitting between the connecting plate 12 and the fixed base 11, the positions of the vibrator D and the fixed base 11 can be fixed in advance, which can effectively reduce the problem as the staff need to support the vibrator D and the fixed base 11 at the mounting positions during mounting, thereby effectively reducing the workload of the staff and further improving the mounting efficiency.

It should be noted that the fixed base 11 and the storage tank are fixed by welding, the connecting plate 12 is flush with the end face of the fixed base 11, and the connecting plate 12 and the vibrator D are fixed by welding. The connecting plate 12 and the bulge 121 are integrally formed, and the bulge 121 is arranged on the surface of the connecting plate 12, so that the bulge 121 can extend to the interior of the fixed base 11.

The clamp 13 penetrates the side wall of the fixed base 11 and extends into the interior thereof. With the fitting between the clamp 13 and the bulge 121, the position of the bulge can be better fixed, thereby ensuring the stability of the connection between the connecting plate 12 and the fixed base 11.

Specifically, a groove is provided in the bulge 121. When the connecting plate 12 to the fixed base 11 is connected, the end of the bulge 121 squeezes the end of the clamp 13, so that the end of the clamp 13 moves away from both sides. Then, when the groove in the bulge 121 corresponds to the position of the clamp 13, the clamp 13 can fit with the groove in the bulge 121 under the bounce force of the reset member, so that the end of the clamp 13 can be snap-fitted into the groove in the bulge 121, and then the positions of the connecting plate 12 and the fixed base 11 can be fixed.

During mounting, the connecting plate 12 connected to the vibrator is aligned with the fixed base 11, so that the bulge 121 penetrates into the interior of the fixed base 11. When the bulge 121 moves toward the interior of the fixed base 11, the end face of the bulge 121 continuously squeezes the end of the clamp 13, causing the clamp 13 to move away from both sides. Then, when the bulge 121 moves to a position where its groove corresponds to the position of the clamp 13, the reset member connected to the end of the clamp 13 pushes the end of the clamp 13 to move toward the groove on the side wall of the bulge 121, so that the clamp 13 is snap-fitted into the groove, to fix the positions of the connecting plate 12 and the fixed base 11, thereby fixing the position of the vibrator.

In summary, with the fitting between the clamp 13 and the connecting plate 12, the position of the vibrator can be quickly fixed in advance, thereby avoiding the need for workers to lift the vibrator during mounting and reducing the labor intensity of workers.

As an optional embodiment, the fixed base 11 includes a through hole 111 in the sidewall thereof and a retainer plate 112 arranged in the through hole 111; the clamp 13 includes a groove 131 on an end face thereof and a first reset member 132 arranged in the groove 131; and the clamp 13 passes through the through hole 111 and extends to the outer side thereof, and the groove 131 is adapted to the retainer plate 112.

In this embodiment, the fixed base 11 is a hollow rectangular structure, and the fixed base 11 and the storage tank are fixed by bolted connection. In order to further ensure that the clamp 13 can penetrate into the inner side of the fixed base 11, a through hole 111 is provided on the side wall of the fixed base 11, so that the clamp 13 can penetrate into the interior of the fixed base 11.

It should be noted that a retainer plate 112 is connected to the center position of the through hole 111, and the groove 131 and the retainer plate 112 are adapted to each other. The retainer plate 112 can limit the movement trajectory of the groove 131, so that the groove 131 can only move along its horizontal direction.

Specifically, an extension plate is provided at the end and side wall of the clamp 13, and the extension plate can limit the movement trajectory of the clamp 13, to ensure that the clamp 13 will not detach from the side wall of the fixed base 11.

During the movement, the clamp 13 moves along the inner wall of the through hole 111, and the movement trajectory of the clamp 13 can be limited by the extension plates at the end and side wall of the clamp 13, so that the clamp 13 can only move within a small range, and will not be completely separated from the fixed base 11.

In an embodiment of the present application, an end of a clamp 13 is a trapezoidal structure, and the outer wall of a bulge 121 is provided with a slot 1211 adapted to the end of the clamp 13; and one end of a first reset member 132 contacts against the groove 131, and the other end contacts against the bulge 121. The first reset member 132 can push the end of the clamp 13 to be snapped in the inner side of the slot 1211.

In this embodiment, as an end of the clamp 13 is a trapezoidal structure, when the bulge 121 moves downward, the end of the bulge 121 can be driven to contact against the inclined surface of the clamp 13, and when the bulge 121 continuously moves downward, the clamp 13 can be squeezed to move along the inner wall of the through hole 111, thereby providing a sufficient space for the clamp 13 to enter the interior of the through hole 111.

Furthermore, the inner side of the groove 131 is further provided with the first reset member 132, and one end of the first reset member 132 is fixedly connected to the clamp 13. When the clamp 13 is squeezed to move to one side, the other end of the first reset member 132 contacts against the end face of the retainer plate 112, so that the first reset member 132 is in a compressed energy storage state.

Specifically, the slot 1211 is provided around the side wall of the bulge 121 to ensure more room for the end of the clamp 13 to adapt to the slot 1211, so that the clamp 13 and the connecting plate 12 can be more flexible during connecting.

The first reset member 132 is preferably a spring. When the end of the clamp 13 is no longer squeezed by the bottom of the bulge 121, the first reset member 132 releases the stored elastic energy, to push the clamp 13 to return to its original position, so that the end of the clamp 13 can be snap-fitted into the slot 1211.

In some embodiment methods, the fixed base 11 further includes a guide sleeve 113 arranged therein, and a pressure rod 14 is arranged in the guide sleeve 113. The clamp 13 further includes a middle hole 133 on a side wall thereof. The pressure rod 14 includes a second reset member 141 arranged at an end thereof and a guide rod 143 arranged on the side wall of the pressure rod 14. The guide rod 143 is adapted to the middle hole 133, and an end of the guide rod 143 passes through to the inner side of the middle hole 133. The movement of the pressure rod 14 in the vertical direction can drive the clamp 13 to move in the horizontal direction.

In this embodiment, the guide sleeve 113 is fixedly arranged in the fixed base 11, and the guide sleeve 113 is a hollow structure. The pressure rod 14 passes through the guide sleeve 113 and extends into the interior thereof, and the provided guide sleeve 113 can limit the movement trajectory of the pressure rod 14, thereby ensuring that the pressure rod 14 can move along the axial direction of the guide sleeve 113.

Further, the side wall of the clamp 13 is provided with an inclined middle hole 133, and the middle hole 133 is adapted to the guide rod 143. The middle hole 133 is provided on the side wall near the end of the clamp 13. The guide rod 143 is fixedly arranged on the side wall of the pressure rod 14, and the end of the guide rod 143 can pass through to the interior of the middle hole 133. When the pressure rod 14 moves in the vertical direction, the side wall of the guide rod 143 can squeeze the inner wall of the middle hole 133, thereby pushing the clamp 13 to move in the horizontal direction.

When it is necessary to separate the clamp 13 from the bulge 121, the pressure rod 14 can be pressed down so that the pressure rod 14 moves in the vertical direction, and then the movement of the pressure rod 14 drives the clamp 13 to move in the horizontal direction, making the end of the clamp 13 move away from the slot 1211, thereby releasing the limit of the clamp 13 on the connecting plate 12.

As an optional embodiment, a push rod 15 is arranged in the pressure rod 14, and the push rod 15 penetrates the fixed base 11 and extends to the outer side thereof. The push rod 15 includes a third reset member 151 arranged therein and a disc 153 arranged at an end of the push rod 15. One end of the third reset member 151 contacts against the inner wall of the pressure rod 14, and the other end contacts against the inner wall of the push rod 15.

In this embodiment, the push rod 15 is connected to the pressure rod 14, and the push rod 15 penetrates the fixed base 11 and the connecting plate 12 and extends to the end of the connecting plate 12, so that the end of the push rod 15 protrudes from the surface of the connecting plate 12. The pressure rod 14 is a hollow structure, and the push rod 15 passes through the pressure rod 14 and extends into the interior thereof.

Further, the push rod 15 is a hollow structure, with a third reset member 151 further arranged therein, and the third reset member 151 is preferably a spring. When the push rod 15 is squeezed and moves downward, the third reset member 151 is compressed, and the push rod 15, which is hollow inside, provides a sufficient space for the third reset member 151 to be compressed.

Specifically, the disc 153 is arranged at the end of the push rod 15. When the disc 153 is squeezed, the end face of the disc 153 contacts against the top of the pressure rod 14, so that the movement of the push rod 15 can drive the pressure rod 14 to move synchronously.

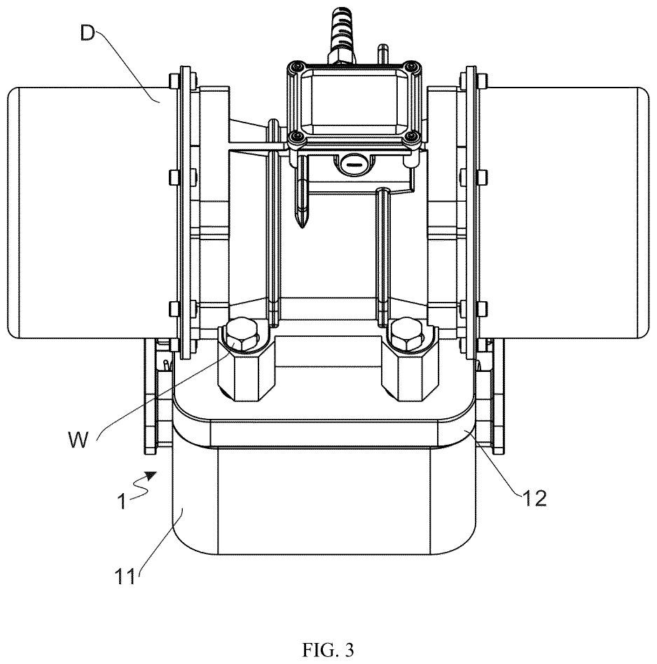

Referring to FIG. 3 to FIG. 5, in an embodiment provided by the present application, the push rod 15 further includes a protrusion 152 arranged on the side wall thereof. The end of the push rod 15 passes through to the inner side of the pressure rod 14. A chute 142 is provided on the inner wall of the pressure rod 14, and the chute 142 is adapted to the protrusion 152.

In this embodiment, the protrusion 152 is fixedly arranged on the side wall of the push rod 15, and the end of the protrusion 152 penetrates into the inner side of the chute 142. The protrusion 152 is adapted to the chute 142, to ensure the linkage between the pressure rod 14 and the push rod 15.

Specifically, the end of the protrusion 152 penetrates into the inner side of the chute 142, and the outer wall of the protrusion 152 contacts against the inner wall of the chute 142, so that the movement of the push rod 15 can drive the pressure rod 14 to move.

In some embodiment methods, the chute 142 includes a vertical section L1 thereof, and the protrusion 152 moves along the vertical section L1; and the push rod 15 moves toward the inside of the pressure rod 14.

In this embodiment, when the protrusion 152 corresponds to the position of the vertical section L1 of the chute 142, the push rod 15 can drive the protrusion 152 to slide along the internal track of the chute 142 when it moves in the vertical direction. Then, the pressure rod 14 moves synchronously with the push rod 15.

Further, as the push rod 15 continuously moves downward, the end face of the disc 153 contacts against the end of the pressure rod 14, and causing the push rod 15 to move and squeezing the pressure rod 14 to move, so that the pressure rod 14 moves synchronously with the push rod 15, thereby controlling the clamp 13 to move away from the connecting plate 12.

Specifically, during mounting, after the vibrator and the storage tank are mounted in advance, bolts penetrate the connecting plate 12 and are engaged with the threaded holes inside the fixed base 11. As the screws approach the fixed base 11, the screws will squeeze the push rod 15, making the push rod 15 move toward the push rod 14. When the disc 153 contacts against the end face of the pressure rod 14, the pressure rod 14 can be driven to move synchronously with the push rod 15. When the pressure rod 14 moves in the vertical direction, the clamp 13 can be driven to move in the horizontal direction. Furthermore, when the connecting plate 12 and the fixed base 11 are pressed tightly by the bolt, the clamp 13 can be kept away from the slot 1211, thereby reducing the contact between the connecting plate 12 and the clamp 13 during the operation of the vibrator, and further ensuring that the clamp 13 can serve for a long time.

In some embodiment methods, the chute 142 further includes a horizontal section L2, and the protrusion 152 moves in the horizontal section. The push rod 15 can drive the pressure rod 14 to move synchronously in the vertical direction.

In this embodiment, the chute 142 further includes a horizontal section L2, and the horizontal section L2 is arranged perpendicular to the vertical section L1. The protrusion 152 needs to rotate a certain angle before entering the inner side of the horizontal section L2. When the protrusion 152 is in the chute 142, the push rod 15 moves in the vertical direction to drive the pressure rod 14 to move synchronously.

After the bolts are removed, the first reset member 132 releases the elastic potential energy to push the clamp 13 to return to its original position, so that the end of the clamp 13 can penetrate to a position above the end of the connecting plate 12. Then, when it is necessary to reach the connection between the clamp 13 and the connecting plate 12, the push rod 15 can be rotated to make the protrusion 152 snap-fitted into the horizontal section L2. Then, the clamp 13 can be pressed down, so that the clamp 13 drives the pressure rod 14 to move downward synchronously. Then, as the pressure rod 14 moves, the clamp 13 can be driven to move away from the slot 1211, thereby releasing the limit on the connecting plate 12. Then, the connecting plate 12 can be taken out from the fixed base 11.

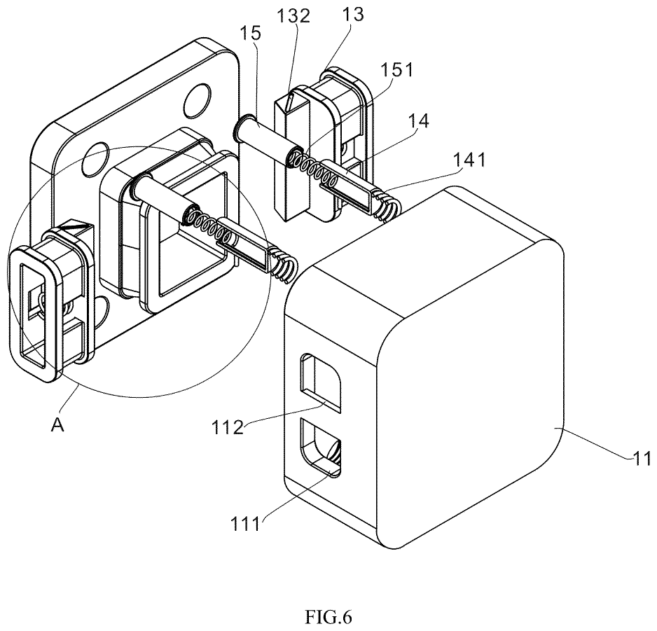

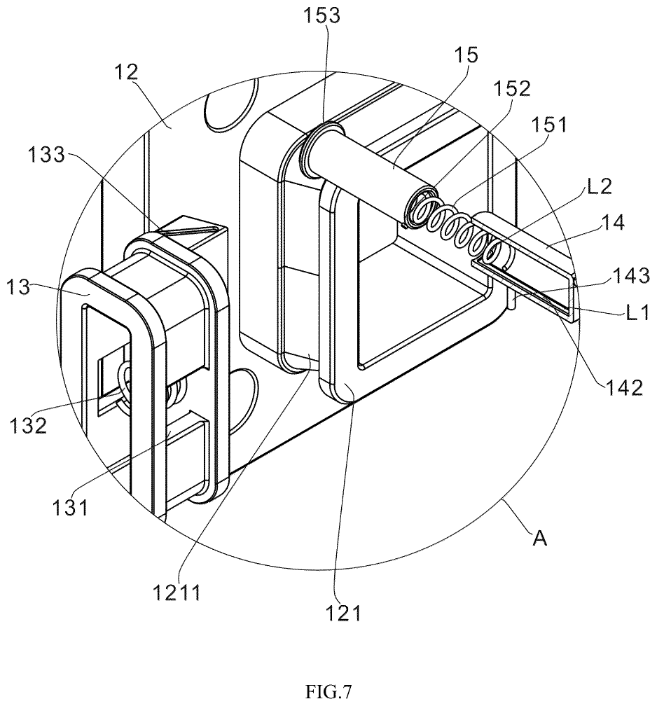

Referring to FIG. 6 and FIG. 7, in an embodiment provided by the present application, the flexible pulping machine includes a storage unit 2, which includes a storage tank 21 and a receiving hopper 22 arranged in the storage tank 21. The fixed base 11 is mounted on the side wall at the bottom of the storage tank 21. The receiving hopper 22 divides the interior of the storage tank 21 into a first storage space M1 and a second storage space M2. A first feeding member 23 is arranged on one side of the first storage space M1, and a second storage space M2 is connected to the second feeding member 24. The first storage space M1 discharges the content through a second discharge pipe 221 connected to the bottom of the receiving hopper 22. The second storage space M2 discharges the content through a first discharge pipe 211 connected to the bottom of the storage tank 21.

In this embodiment, the receiving hopper 22 divides the interior of the storage tank 21 into two unconnected storage chambers to better distinguish lime powders from limestone. Different pulping machines can be connected to the discharge port at the bottom of the silo to better manufacture limestone slurry.

The fixed base 11 is mounted at the bottom of the storage tank 21, and the fixed base 11 and the storage tank 21 are fixed by welding. The fixed base 11 is adapted to the connecting plate 12, to further ensure the stability of the vibrator mounted.

Specifically, limestone is stored in the first storage space M1, and the first storage space M1 is fed by the first feeding member 23, which is a spiral feeding structure in the prior art, and rotates to feed the material into the first storage space M1.

Lime powders are stored in the second storage space M2, and the second storage space M2 is fed by the second feeding member 24. The first feeding member 23 has the same structure as the second feeding member 24.

A first discharge pipe 211 is arranged at the bottom of the storage tank 21, and the lime powders stored herein can be sent through the first discharge pipe 211 to the mixing and pulping machine, for preparation of limestone slurry.

A second discharge pipe 221 is arranged at the bottom of the receiving hopper 22, and is connected to the interior of the first storage space M1. The limestone can be sent through the second discharge pipe 221 to the corresponding wet ball mill for preparation of limestone slurry from the limestone blocks.

The vibrator is mounted at the discharge port to ensure smooth discharging of the raw limestone from the storage tank, effectively preventing the discharge port from being blocked.

Referring to FIG. 1 to FIG. 3, this embodiment provides a method for mounting the flexible pulping machine with anti-clogging devices for a thermal power plant, including S1: connecting and fixing the vibrator to the connecting plate.

S2: inserting the connecting plate into the inner side of a fixed base, and further fixing the positions of the fixed base and the connecting plate by using the fitting between a clamp and the connecting plate.

Specifically, the protrusion arranged at the end of the connecting plate penetrates into the interior of the fixed base, and the end of the protrusion is used to squeeze the inclined surface of the clamp, to make the clamp away from the connecting plate. As the protrusion continues to extend into the interior of the fixed base, the position of the clamp corresponds to the position of the slot, and then the reset member pushes the clamp into the slot, thereby fixing the positions of the connecting plate and the fixed base.

After the fitting is complete, the positions of the vibrator connected to the connecting plate and the fixed base are fixed, so that the positions of the vibrator and the storage tank are fixed. Then, when the bolts are mounted, no staff support is required, and the positions of the bolts have matched the positions of the screw holes one by one, so that the vibrator can be mounted quickly with lower labor intensity.

S3: then making bolts penetrate the connecting plate and engage with the screw holes inside the fixed base, so that the vibrator can be fixed at the bottom of the storage tank.

Specifically, the bolts then penetrate the connecting plate and extend into the interior of the fixed base. In this way, multiple groups of bolts are sequentially mounted between the connecting plate and the fixed base, and then the multiple groups of bolts are tightened synchronously to press and fix the fixed base and the connecting plate.

As the bolts are tightened, the ends of the bolts gradually squeeze the end of the push rod. When the push rod is compressed, the protrusion moves along the vertical section of the chute. When the disc contacts against the end of the pressure rod, the movement of the push rod can drive the pressure rod to move in the vertical direction, to drive the clamp to move in the horizontal direction, so that the clamp moves away from the inner side of the slot, and the clamp no longer contacts against the connecting plate. Then, when being affected by vibration, the clamp bears less force, thereby ensuring its service life and facilitating long-term operation of the device.

Finally, it should be noted that the methods and devices described in detail above are only embodiments, and those skilled in the art can modify these embodiments in different ways as long as they do not depart from the scope of the present application.

What is claimed is:

1. A flexible pulping machine with anti-clogging devices for a thermal power plant, comprising:
a pre-positioning unit (1), which comprises a fixed base (11), a connecting plate (12) arranged at one end of the fixed base (11), and a clamp (13) penetrating a side wall of the fixed base (11), wherein
an end face of the connecting plate (12) is connected to the bottom of a vibrator D, and the connecting plate (12) comprises a bulge (121) arranged at an end thereof; and
the bulge (121) penetrates the fixed base (11) and extends into the interior thereof, and the clamp (13) contacts against the bulge (121), thereby realizing the fixation between the fixed base (11) and the connecting plate (12).

2. The flexible pulping machine with anti-clogging devices for a thermal power plant according to claim 1, wherein
the fixed base (11) comprises a through hole (111) on a side wall thereof and a retainer plate (112) arranged in the through hole (111);
the clamp (13) comprises a groove (131) on an end face thereof and a first reset member (132) arranged in the groove (131); and
the clamp (13) passes through the through hole (111) and extends to the outer side thereof, and the groove (131) is adapted to the retainer plate (112).

3. The flexible pulping machine with anti-clogging devices for a thermal power plant according to claim 2, wherein
an end of the clamp (13) is a trapezoidal structure, and the outer wall of the bulge (121) is provided with a slot (1211) adapted to the end of the clamp (13);
one end of the first reset member (132) contacts against the groove (131), and the other end thereof contacts against the bulge (121); and
the first reset member (132) can push the end of the clamp (13) to be snapped in the inner side of the slot (1211).

4. The flexible pulping machine with anti-clogging devices for a thermal power plant according to claim 3, wherein
the fixed base (11) further comprises a guide sleeve (113) arranged therein, and a pressure rod (14) is arranged in the guide sleeve (113);
the clamp (13) further comprises a middle hole (133) on a side wall thereof;
the pressure rod (14) comprises a second reset member (141) arranged at an end thereof and a guide rod (143) arranged on a side wall of the pressure rod (14);
the guide rod (143) is adapted to the middle hole (133), and an end of the guide rod (143) passes through to the inner side of the middle hole (133); and
the movement of the pressure rod (14) in the vertical direction can drive the clamp (13) to move in the horizontal direction.

5. The flexible pulping machine with anti-clogging devices for a thermal power plant according to claim 4, wherein
a push rod (15) is arranged in the pressure rod (14), and the push rod (15) penetrates the fixed base (11) and extends to the outer side thereof;
the push rod (15) comprises a third reset member (151) arranged therein and a disc (153) arranged at an end of the push rod (15); and
one end of the third reset member (151) contacts against the inner wall of the pressure rod (14), and the other end contacts against the inner wall of the push rod (15).

6. The flexible pulping machine with anti-clogging devices for a thermal power plant according to claim 5, wherein
the push rod (15) further comprises a protrusion (152) arranged on the side wall thereof;
an end of the push rod (15) passes through to the inner side of the pressure rod (14); and
a chute (142) is provided on the inner wall of the pressure rod (14), and the chute (142) is adapted to the protrusion (152).

7. The flexible pulping machine with anti-clogging devices for a thermal power plant according to claim 6, wherein
the chute (142) comprises a vertical section L1, and the protrusion (152) moves along the vertical section L1; and
the push rod (15) moves toward the inside of the pressure rod (14).

8. The flexible pulping machine with anti-clogging devices for a thermal power plant according to claim 6, wherein
the chute (142) further comprises a horizontal section L2, and the protrusion (152) moves in the horizontal section; and
the push rod (15) can drive the pressure rod (14) to move synchronously in the vertical direction.

9. The flexible pulping machine with anti-clogging devices for a thermal power plant according to claim 1, further comprising:
a storage unit (2), which comprises a storage tank (21) and a receiving hopper (22) arranged in the storage tank (21); wherein the fixed base (11) is mounted on the side wall at the bottom of the storage tank (21);
the receiving hopper (22) divides the interior of the storage tank (21) into a first storage space M1 and a second storage space M2;
a first feeding member (23) is provided on one side of the first storage space M1, and a second feeding member (24) is connected to the second storage space M2;
the first storage space M1 discharges the content through a second discharge pipe (221) connected to the bottom of the receiving hopper (22); and
the second storage space M2 discharges the content through a first discharge pipe (211) connected to the bottom of the storage tank (21).

10. A method for mounting the flexible pulping machine with anti-clogging devices for a thermal power plant, comprising:
S1: connecting and fixing a vibrator to a connecting plate;
S2: inserting the connecting plate into the inner side of a fixed base, and further fixing the positions of the fixed base and the connecting plate by using the fitting between a clamp and the connecting plate; and
S3: then making bolts penetrate the connecting plate and engage with screw holes inside the fixed base, so that the vibrator can be fixed at the bottom of a storage tank.
